(19) United States
(12) Patent Application Publication
(10) Pub. No.: US 2017/0148177 A1
(43) Pub. Date: May 25, 2017

(54) IMAGE PROCESSING APPARATUS, IMAGE PROCESSING METHOD, AND PROGRAM

(71) Applicant: SONY CORPORATION, TOKYO (JP)

(72) Inventor: SHUICHI TAKAHASHI, KANAGAWA (JP)

(21) Appl. No.: 15/127,655

(22) PCT Filed: Mar. 31, 2015
(86) PCT No.: PCT/JP2015/001856

§ 371 Date: Sep. 20, 2016

(30) Foreign Application Priority Data
Jun. 3, 2014 (JP) 2014-114545

(51) Int. Cl. G06T 7/246; G06K 9/20; G06K 9/52; G06T 7/536; G06T 7/70

(52) U.S. Cl. CPC G06T 7/246; G06T 7/536; G06T 7/70; G06K 9/52; G06K 9/20; G06T 2207/20024

(57) ABSTRACT

[Object] To provide an image processing apparatus, an image processing method, and a program with which an output image group, that makes people feel that an object is moving appropriately, can be generated for each processing unit of an input image. [Solving Means] According to an embodiment of the present technology, there is provided an image processing apparatus including a control amount regulation unit and a filter generation unit. The control amount regulation unit specifies, based on image information of an input image including a plurality of processing units, a control amount of a movement to be sensed for each of the processing units. The filter generation unit generates, for each of the processing units, a plurality of space filters with which an output image group, that causes the movement to be sensed, can be generated from the input image based on the specified control amount.

### TECHNICAL FIELD

The present technology relates to an image processing apparatus, an image processing method, and a program with which images that use a movement illusion can be generated.

### BACKGROUND ART

There is known a technology capable of generating a plurality of still images that give an impression that an object is moving when the images are reproduced consecutively (Non-patent Document 1). More specifically, the plurality of still images are generated by applying, as a space filter, a function including a phase parameter to still images and executing processing using a plurality of space filters whose phase parameters are varied. By consecutively reproducing the generated still images, it becomes possible to give an impression as if the object is moving.

Non-patent Document 1: “Motion Without Movement”, W. T. Freeman et. al, Computers & Graphics, Elsevier, Vol. 25(4), pp. 27-30, 1991

### SUMMARY

### Problem to be Solved

In the technology described in Non-patent Document 1, however, it has been possible to express only the movements of the same size and direction in the entire image.

In view of the circumstances as described above, the present technology aims at providing an image processing apparatus, an image processing method, and a program with which an output image group, that makes people feel that an object is moving appropriately, can be generated for each processing unit of an input image.

### Means for solving the Problem

To attain the object described above, according to an embodiment of the present technology, there is provided an image processing apparatus including a control amount regulation unit and a filter generation unit.

The control amount regulation unit specifies, based on image information of an input image including a plurality of processing units, a control amount of a movement to be sensed for each of the processing units.

The filter generation unit generates, for each of the processing units, a plurality of space filters with which an output image group, that causes the movement to be sensed, can be generated from the input image based on the specified control amount.

With this configuration, it becomes possible to determine the movement to be sensed for each processing unit based on the image information and generate a space filter capable of realizing such a movement. Accordingly, it becomes possible to generate an output image group that makes people feel that an appropriate movement is being made for each processing unit.

Further, the control amount may be an amount that specifies at least one of a size and a direction of the movement to be sensed.

With this configuration, it becomes possible to accurately specify the movement to be sensed.

The image information may include a feature amount extracted from the input image.

With this configuration, it becomes possible to make the movement to be sensed match the depth information, object, composition, and the like of the input image and generate an output image closer to the real thing.

Further, the feature amount may include depth information of the input image, and the control amount regulation unit may specify, based on the depth information, the control amount such that the movement is sensed more largely in a processing unit having a larger depth than a processing unit having a smaller depth.

With this configuration, it becomes possible to generate an output image group with which people can feel a sense of depth more.

The feature amount may include scene information on a scene estimated from the input image, and the control amount regulation unit may specify the control amount for each of the processing units based on the scene information.

With this configuration, it becomes possible to generate an output image group that feels more natural according to the scene of the input image.

For example, the scene information may include information on a space configuration in the input image.

Alternatively, the scene information may include information on a type of an object of the input image.

Further, the feature amount may include information on a position of at least one of a vanishing point and a vanishing line of the input image, and the control amount regulation unit may specify the control amount such that a movement toward at least one of the vanishing point and the vanishing line or a movement that moves away from at least one of the vanishing point and the vanishing line is sensed.

With this configuration, it becomes possible to generate an output image with which a sense of depth and a stereoscopic effect can be felt more.

Further, the input image may be one of a plurality of images that include the same object and can be reproduced temporally consecutively,

the feature amount may include information on a motion vector of the object in the input image, that is estimated from the plurality of images, and

the control amount regulation unit may specify, as the control amount, a size and direction of the movement based on the motion vector.

With this configuration, it becomes possible to generate an output image with which a movement similar to that of the actual object can be sensed, and make people feel that the output image is closer to the real thing.

Further, the feature amount may include information on a gaze area presumed to be gazed out of the input image, and the control amount regulation unit may specify different control amounts for the gaze area and areas excluding the gaze area.

With this configuration, it becomes possible to generate an output image group in which the gaze area can be expressed more naturally.

Further, the image processing apparatus may further include:

an image acquisition unit that acquires the input image; and

an image information analysis unit that analyzes the image information from the input image.

With this configuration, it becomes possible to analyze the image information in the image processing apparatus.

Further, each of the plurality of space filters may include a function expressed by a trigonometric function, the functions of the plurality of space filters including different phase parameter values.

With this configuration, it becomes possible to adjust the phase parameter values and adjust the movement to be sensed.

The plurality of space filters may each include a Gabor filter, the Gabor filters of the plurality of space filters including different phase parameter values.

With this configuration, it becomes possible to generate space filters having relatively-small operation amounts and reduce processing costs. Furthermore, since the parameters of the Gabor filters can be understood intuitively from the shape of the filters in many cases, the parameter values can be set with ease.

Further, the image processing apparatus may further include a storage unit that stores a lookup table including a plurality of array groups that can be applied as the plurality of space filters, and

the filter generation unit may select an array group from the lookup table for each of the processing units based on the control amount.

With this configuration, it becomes possible to omit time and effort required for generating the plurality of space filters every time processing is carried out and thus reduce processing costs more.

Further, the image processing apparatus may further include

a processing execution unit that applies the plurality of space filters to each of the processing units of the input image to generate an output image group.

According to an embodiment of the present technology, there is provided an image processing method including specifying, based on image information of an input image including a plurality of processing units, a control amount of a movement to be sensed for each of the processing units.

For each of the processing units, a plurality of space filters with which an output image group, that causes the movement to be sensed, can be generated from the input image are generated based on the specified control amount.

Further, according to an embodiment of the present technology, there is provided a program that causes an image processing apparatus to execute the steps of:

specifying, based on image information of an input image including a plurality of processing units, a control amount of a movement to be sensed for each of the processing units; and

generating, for each of the processing units, a plurality of space filters with which an output image group, that causes the movement to be sensed, can be generated from the input image based on the specified control amount.

### Effects

As described above, according to the present technology, it becomes possible to provide an image processing apparatus, an image processing method, and a program with which an output image group, that makes people feel that an object is moving appropriately, can be generated for each processing unit of an input image.

It should be noted that the effects described herein are not necessarily limited, and any effect described in the present disclosure may be obtained.

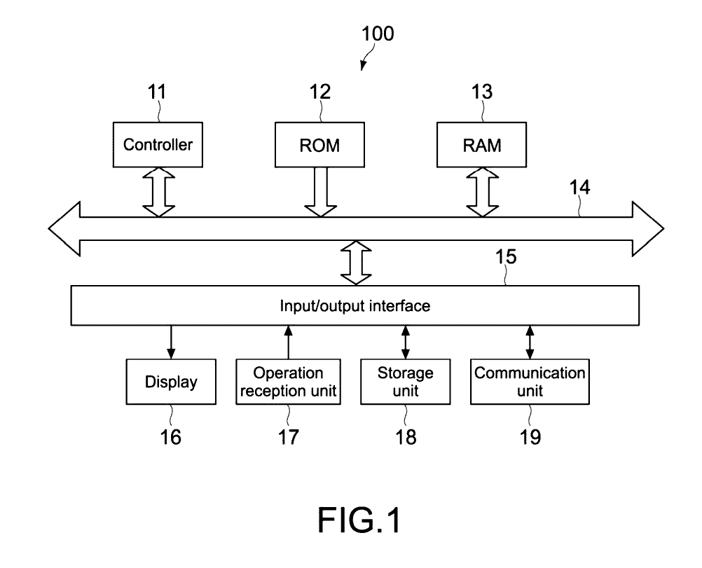

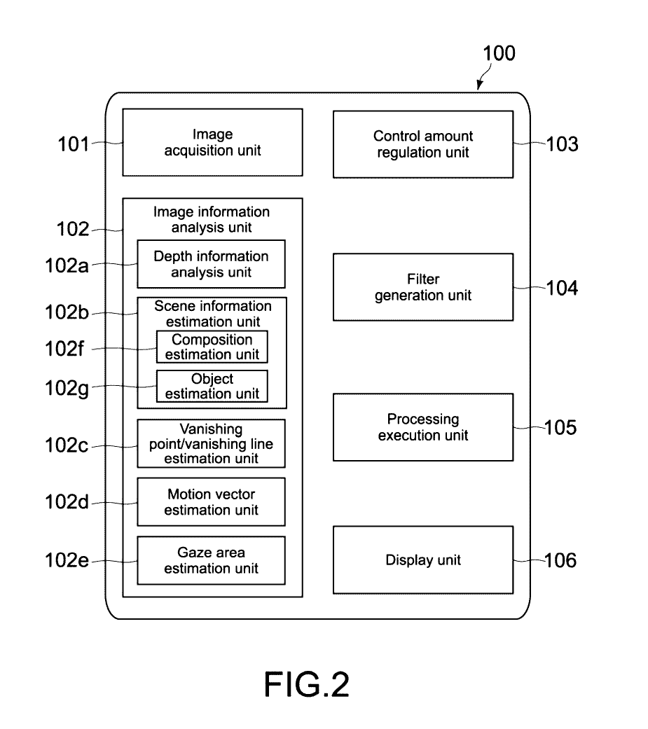

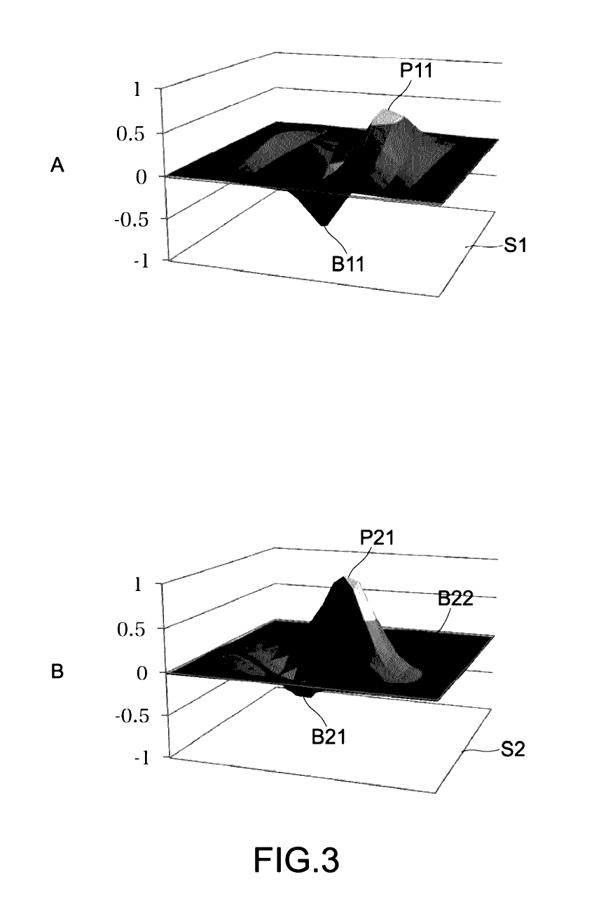

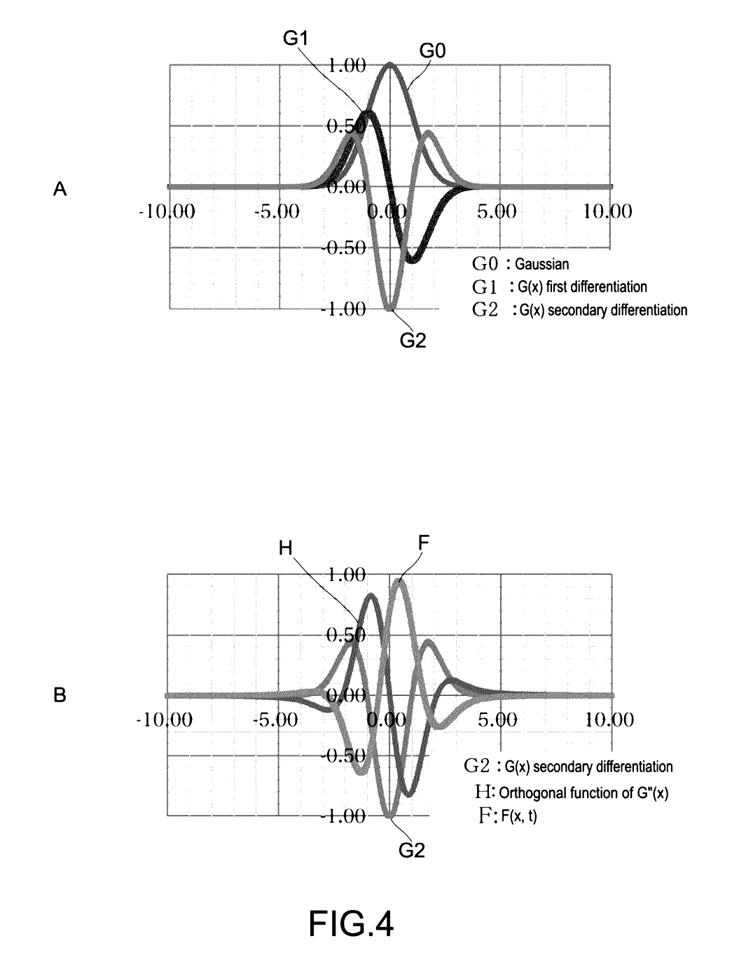

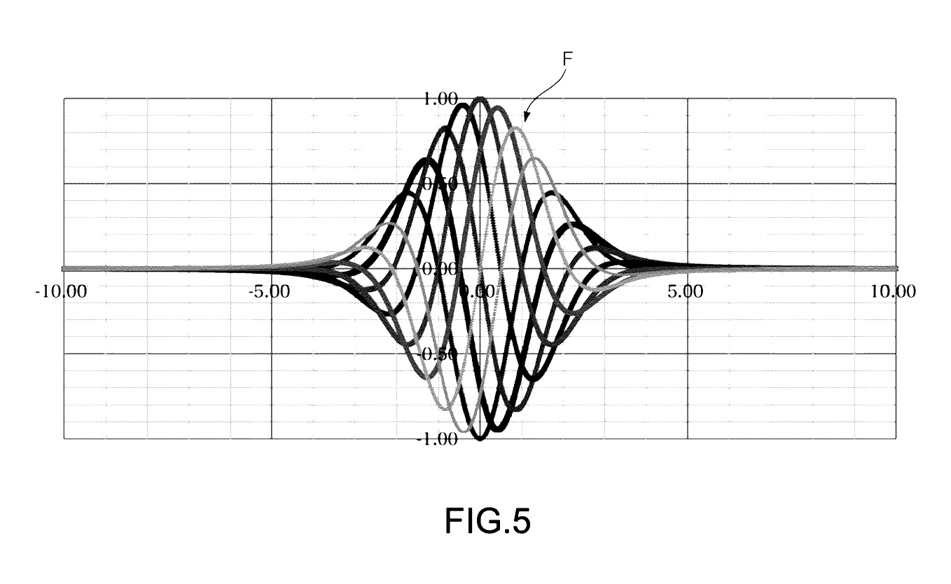

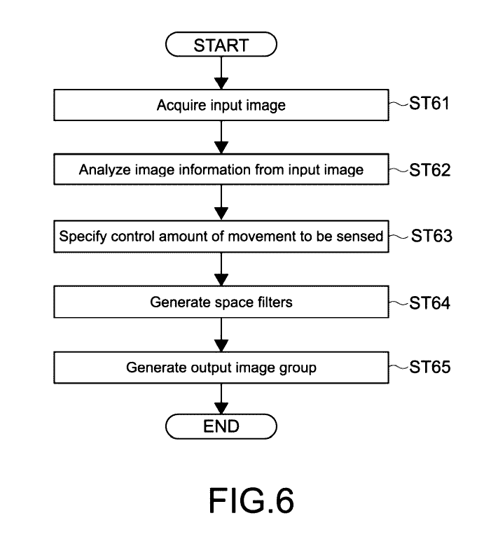

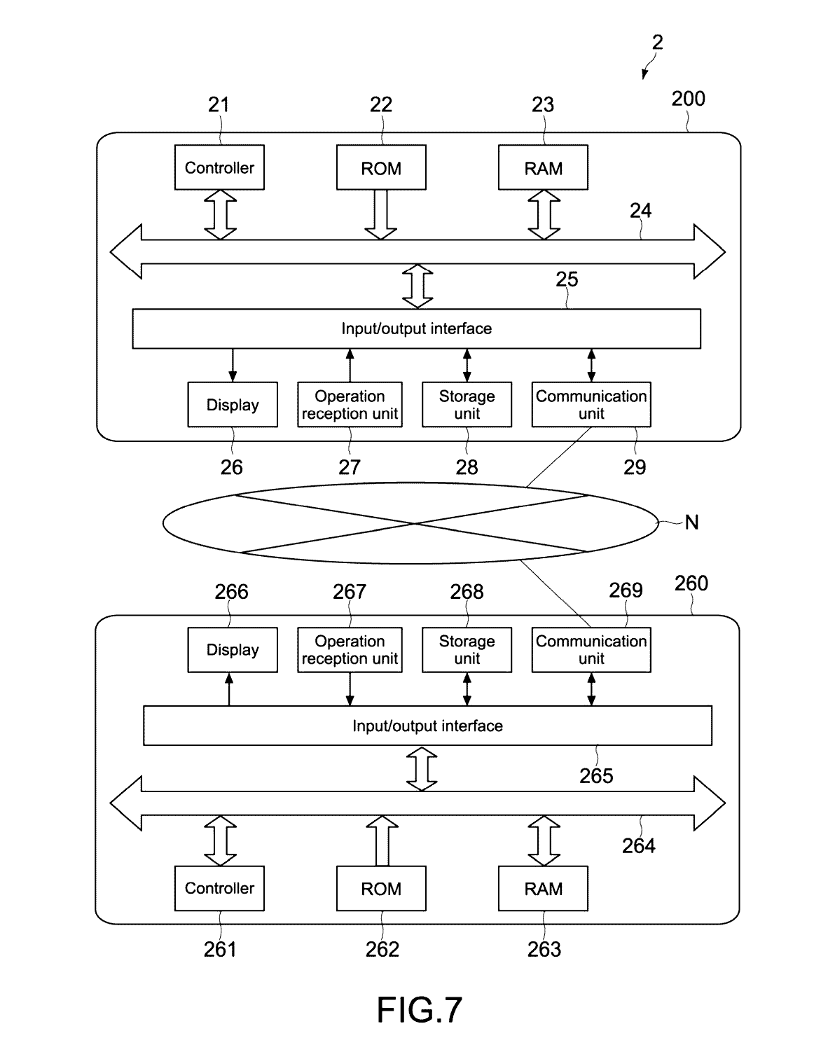

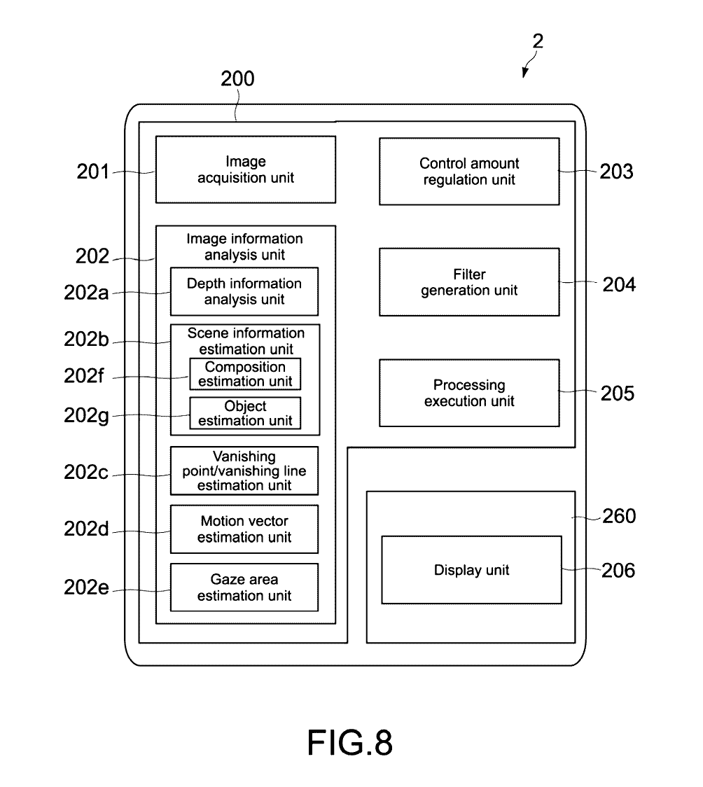

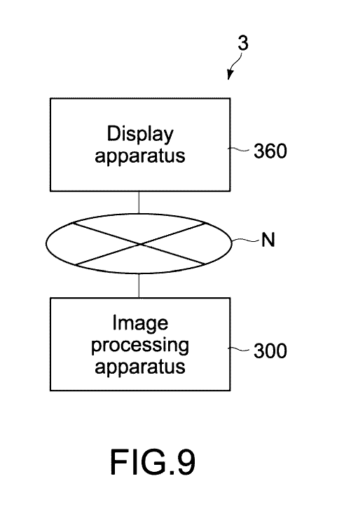

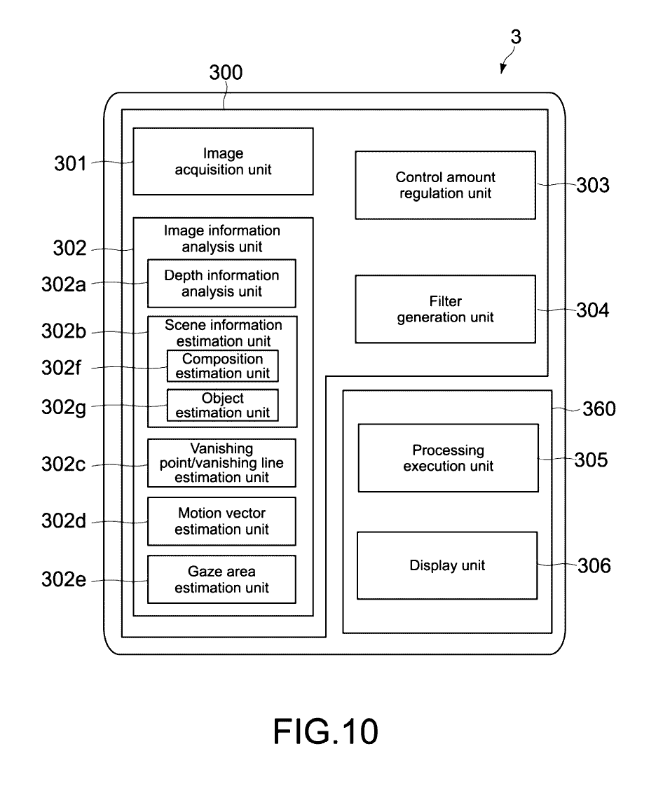

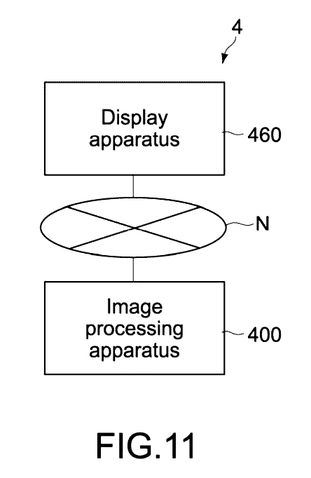

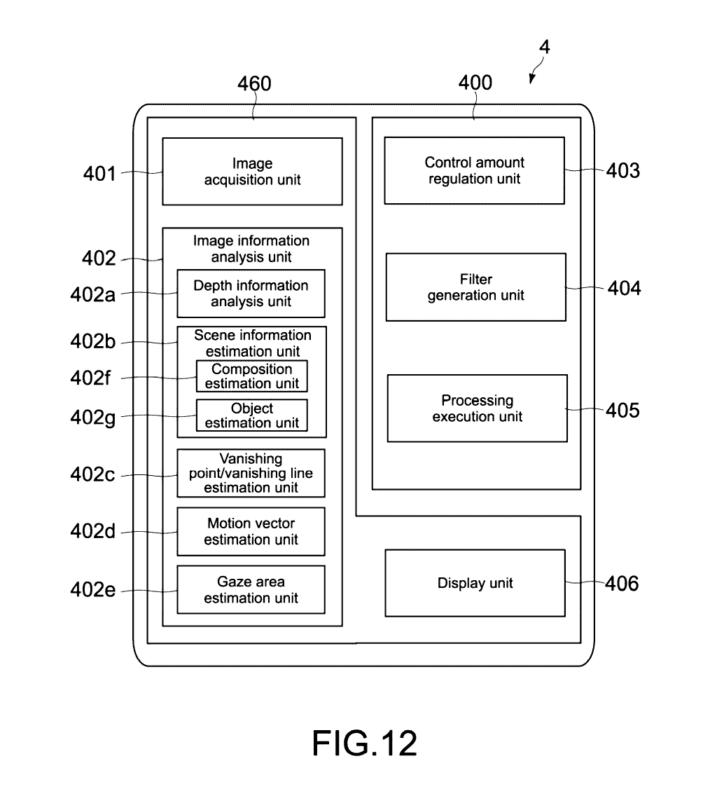

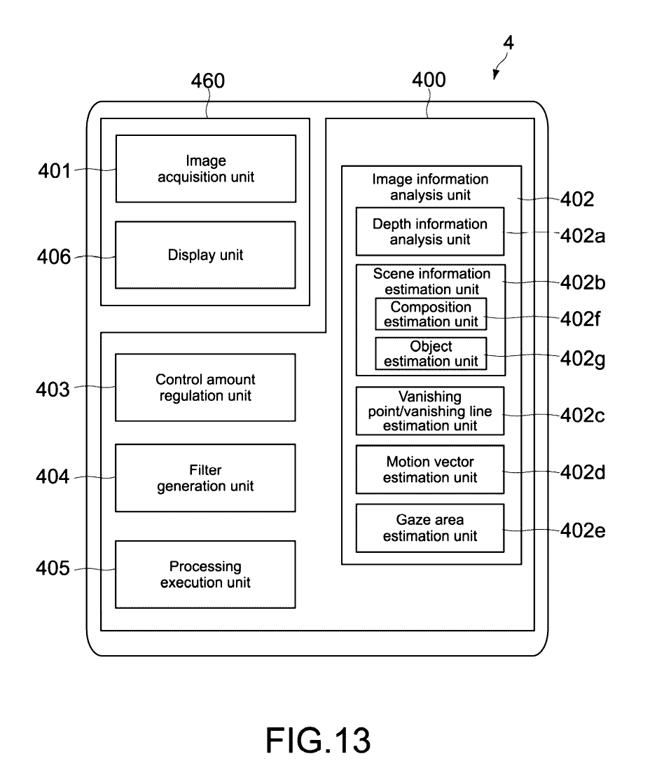

### BRIEF DESCRIPTION OF DRAWINGS

[FIG. 1] A block diagram showing a hardware configuration of an image processing apparatus according to a first embodiment of the present technology.

[FIG. 2] A block diagram showing a functional configuration of the image processing apparatus.

[FIG. 3] Diagrams each showing a specific shape example of a Gabor filter.

[FIG. 4] Diagrams for explaining a function that uses a gauss function, the function being used in a space filter.

[FIG. 5] A graph showing a shape example of the function at a different time t.

[FIG. 6] A flowchart showing operations of the image processing apparatus.

[FIG. 7] A block diagram showing a hardware configuration of an image processing system according to a second embodiment of the present technology.

[FIG. 8] A block diagram showing a functional configuration of the image processing system.

[FIG. 9] A block diagram showing a schematic configuration of an image processing system according to a third embodiment of the present technology.

[FIG. 10] A block diagram showing a functional configuration of the image processing system.

[FIG. 11] A block diagram showing a schematic configuration of an image processing system according to a fourth embodiment of the present technology.

[FIG. 12] A block diagram showing a functional configuration of the image processing system.

[FIG. 13] A block diagram showing a functional configuration of the image processing system according to a modified example.

### DESCRIPTION OF PREFERRED EMBODIMENTS

Hereinafter, embodiments of the present technology will be described with reference to the drawings.

### First Embodiment

(Hardware Configuration of Image Processing Apparatus)

FIG. 1 is a block diagram showing a hardware configuration of an image processing apparatus 100 according to a first embodiment of the present technology. In this embodiment, the image processing apparatus 100 may be configured as an information processing apparatus. Specifically, the image processing apparatus 100 may be an information processing apparatus such as a PC (Personal Computer), a tablet PC, a smartphone, and a tablet terminal.

In the figure, the image processing apparatus 100 includes a controller 11, a ROM (Read Only Memory) 12, a RAM (Random Access Memory) 13, an input/output interface 15, and a bus 14 mutually connecting them.

The controller 11 appropriately accesses the RAM 13 and the like as necessary and carries out various types of operational processing to collectively control the entire blocks of the image processing apparatus 100. The controller 11 may be a CPU (Central Processing Unit), a GPU (Graphics Processing Unit), or the like. The ROM 12 is a nonvolatile memory that fixedly stores an OS to be executed by the controller 11 and firmware such as programs and various parameters. The RAM 13 is used as a working area of the controller 11 and the like and temporarily stores the OS, various applications being executed, and various types of data being processed.

Connected to the input/output interface 15 are a display 16, an operation reception unit 17, a storage unit 18, a communication unit 19, and the like. It should be noted that in addition to those elements, the input/output interface 15 may be connectable to an external peripheral apparatus via a USB (Universal Serial Bus) terminal, an IEEE terminal, and the like. Moreover, in addition to those elements, an image pickup unit (not shown) and the like may also be connected to the input/output interface 15.

The display 16 is a display device that uses an LCD (Liquid Crystal Display), an OLED (Organic Light Emitting Diode), a CRT (Cathode Ray Tube), or the like.

The operation reception unit 17 is a pointing device such as a mouse, a keyboard, a touch panel, or other input apparatuses. When the operation reception unit 17 is a touch panel, the touch panel may be integrated with the display 16.

The storage unit 18 is a nonvolatile memory such as an HDD (Hard Disk Drive), a flash memory (SSD: Solid State Drive), and other solid-state memories. The OS, various applications, and various types of data are stored in the storage unit 18. The storage unit 18 is capable of storing an input image, image information, generated space filters, a generated output image group, and the like that are to be described later.

The communication unit 19 is an NIC (Network Interface Card) for the Ethernet (registered trademark), for example, and assumes communication processing via a network.

The image processing apparatus 100 having the hardware configuration as described above includes a functional configuration as follows.

(Functional Configuration of Image Processing Apparatus)

FIG. 2 is a block diagram showing the functional configuration of the image processing apparatus 100. As shown in the figure, the image processing apparatus 100 includes an image acquisition unit 101, an image information analysis unit 102, a control amount regulation unit 103, a filter generation unit 104, a processing execution unit 105, and a display unit 106. As will be described below, the image processing apparatus 100 is capable of generating, based on image information analyzed from one input image, an output image group that can give an impression that an object in the input image is moving at a time of consecutive reproduction. It should be noted that the “input image” used in this embodiment is typically a still image, but the input image may also be one frame of a moving image.

The image acquisition unit 101 acquires an input image to be processed. The image acquisition unit 101 is realized by the controller 11, for example. The image acquisition unit 101 acquires an image stored in the storage unit 18 via the input/output interface 15 as the input image, for example. The input image may be, for example, an image taken by the image pickup unit (not shown) of the image processing apparatus 100 or an image that has been taken by an external image pickup apparatus or the like and input to the image processing apparatus 100. Alternatively, the input image may be an image acquired via a network.

The image information analysis unit 102 analyzes image information from the acquired input image. The image information analysis unit 102 is realized by the controller 11, for example. The image information may be, for example, a feature amount extracted from an input image. The feature amount is an element indicating a feature that can be extracted from the input image and may include, for example, depth information of the input image to be described later, scene information on a scene estimated from the input image, information on at least one of a vanishing point and a vanishing line of the input image, information on a motion vector of an object in the input image, information on a gaze area presumed to be gazed out of the input image, and the like. By the image information analysis unit 102, it becomes possible to acquire image information used for determining a movement to be sensed.

The image information analysis unit 102 includes, for example, a depth information analysis unit 102a, a scene information estimation unit 102b, a vanishing point/vanishing line estimation unit 102c, a motion vector estimation unit 102d, and a gaze area estimation unit 102e.

The depth information analysis unit 102a analyzes depth information. The depth information refers to information that indicates a relative or absolute perspective relationship (depth position) of objects. The method of analyzing a depth position is not limited in particular. For example, if the input image is a 3D input image, it is possible to use a parallax estimated using input images for a right-eye and a left-eye, or a method of irradiating laser light having a predetermined pattern onto an object and acquiring a pattern distortion of reflected light may be used. Moreover, the analyzed depth information may be expressed as a depth image in which a depth position of an object is indicated by a contrasting density of a predetermined gradation or as numerical value information set for each area of the input image, for example.

It should be noted that the depth information analysis unit 102a can also estimate the depth position of an object by using information on a position of a vanishing line/vanishing point to be described later.

The scene information estimation unit 102b estimates scene information on a scene estimated from the input image. More specifically, the scene information includes information on a composition of the input image, information on a type of an object, and the like. In other words, the scene information estimation unit 102b includes, for example, a composition estimation unit 102f and an object estimation unit 102g.

The composition estimation unit 102f estimates a spatial configuration of the input image as a composition and categorizes it into, for example, indoor, near view, and distant view. The method of estimating a spatial configuration is not limited in particular.

The object estimation unit 102g estimates a type of an object in the input image and categorizes it into, for example, person(s), natural landscape, or urbanscape. The method of estimating an object type is not limited in particular.

The vanishing point/vanishing line estimation unit 102c estimates a position of at least one of a vanishing point and a vanishing line of the input image. Specifically, the vanishing point/vanishing line estimation unit 102c estimates a spatial configuration of the input image and estimates a position of a vanishing line such as a horizon and a sea horizon or a position of a vanishing point from the input image. The method of estimating these positions is not limited in particular. In addition, position information of the estimated vanishing line/vanishing point may be stored in the storage unit 18 in association with XY coordinates allocated to the input image.

The motion vector estimation unit 102d estimates, when the input image is one of a plurality of images that include the same object and can be reproduced temporally consecutively, a motion vector of an object in the image based on the plurality of images. The motion vector indicates a size and direction of a movement. Specifically, the motion vector estimation unit 102d estimates a size and direction of a movement of an object based on a plurality of frames of a moving image including the input image. The method of estimating a motion vector is not limited in particular.

The gaze area estimation unit 102e estimates a gaze area presumed to be gazed out of the input image. The method of estimating a gaze area is not limited in particular. For example, by extracting characteristic objects by an image recognition technique, an area that an object presumed to attract attention out of the plurality of objects occupies can be estimated.

Based on image information of an input image including a plurality of processing units, the control amount regulation unit 103 regulates a control amount of a movement to be sensed for each processing unit. The control amount regulation unit 103 is realized by the controller 11, for example. The expression “(cause) movement to be sensed” used herein means causing, while there is no change in the actual position of an object on an image, people that have seen the image to perceive as if the object is moving based on a change of a luminance value with time.

The control amount is an amount that specifies at least one of a size and direction of a movement to be sensed, for example, and to be specific, may be expressed as at least one of a value that specifies a movement size and a value that specifies a movement direction. The value that specifies a movement direction may be expressed by a combination of xy values or a value of a rotation angle using a certain direction as a reference. Alternatively, the control amount may be expressed by motion vectors indicating the size and direction of a movement.

It should be noted that examples of the processing unit of an input image include one pixel, a block including a plurality of pixels, and one object. In addition, the processing unit may be specified for all pixels in an input image or specified for only a part of the pixels. Moreover, processing units having different pixels counts or shapes may be mixed in one input image. Information analyzed by the image information analysis unit 102 can be used as the image information.

Here, as a method of making people feel that an input image is close to the real thing, there is a method of giving a stereoscopic effect and a sense of depth. A key to feeling a stereoscopic effect and a sense of depth, that is, a key for a depth can be roughly categorized into a monocular depth key (monocular stereoscopic information) for perceiving a depth even with a single eye and a binocular depth key (binocular stereoscopic information) that uses both eyes. Examples of the former case include shielding (occlusion), movements of objects, and aerial perspective, and an example of the latter case is binocular parallax. In the present technology, of the monocular depth keys, the stereoscopic effect and sense of depth can be imparted using the movements of objects that are sensed as being nearer for faster movements and being farther for slower movements.

Based on the specified control amount, the filter generation unit 104 generates a plurality of space filters capable of generating an output image group that causes a movement to be sensed from an input image for each of the processing units. The filter generation unit 104 is realized by the controller 11, for example. The expression “output image group that causes a movement to be sensed” used herein refers to an image group including a plurality of images capable of giving an impression during consecutive reproduction as if, while there is no change in the actual position of an object in an image, an outline of the object has changed and the object is moving based on a change of luminance values and the like. According to this embodiment, the change in the luminance values can be realized by the space filter applied to each of the processing units. It should be noted that when the processing unit includes a plurality of pixels, the filter generation unit 104 can generate one space filter with respect to each of the pixels within one processing unit.

The space filter is generally used in space filtering processing and refers to a filter generated by a predetermined function or matrix. Further, the space filtering processing generally refers to processing of weighting a luminance value of one or a plurality of pixels including a pixel to be processed (center pixel), and the like and setting a value obtained by a predetermined calculation as a value of the center pixel. Hereinafter, one or a plurality of pixels that is/are subjected to a calculation of a space filter applied to a certain center pixel will also be referred to as calculation target pixel group.

The plurality of space filters of this embodiment may include functions that have different phase parameter values and are expressed by a trigonometric function. More specifically, the plurality of space filters may include Gabor filters having different phase parameter values. Here, examples of the functions expressed by a trigonometric function include functions expressed by a trigonometric function (sin function and/or cos function, including that to which coefficient is added) or a sum of those, a product of a trigonometric function and other functions or a sum of those, a sum of a trigonometric function and a product of the trigonometric function and other functions, and the like. By applying the space filters having different phase parameter values as described above to an input image, luminance values in each of the processing units can be periodically varied according to the phase parameter values so that it becomes possible to give an impression as if the object is moving when reproduced as an output image group.

For example, the filter generation unit 104 calculates the functions into which the parameter values corresponding to the control amount are substituted to generate the plurality of space filters. The parameter values may be stored in the storage unit 18 in association with the control amount, or the functions into which the parameter values are substituted may be stored in association with the control amount. Further, in this embodiment, the filter generation unit 104 can also specify a value of a part of the function based on not only the control amount but also image information. Accordingly, not only the movement to be sensed but also edge intensities in each of the processing units, and the like can be adjusted.

The timing at which the filter generation unit 104 generates space filters is not limited in particular. For example, it is possible to generate a plurality of space filters for each of the processing units by generating a space filter with respect to each of the processing units, generating one output image by the processing execution unit 105 to be described later, and repeating these processes. Alternatively, it is also possible for the filter generation unit 104 to generate a plurality of space filters for each of the processing units and the processing execution unit 105 to generate an output image group by applying the plurality of space filters to an input image.

The processing execution unit 105 generates an output image group by applying the plurality of space filters generated by the filter generation unit 104 to the processing units of the input image. Specifically, the processing execution unit 105 generates one output image by applying one of the plurality of space filters to each of the processing units of the input image and repeats this processing for the plurality of space filters in each of the processing units, to generate a plurality of output images. Here, the “output image group” refers to a plurality of images generated from one input image, the plurality of images being images that can cause a predetermined movement to be sensed when the images are consecutively reproduced in a predetermined order.

Further, “applying a space filter to each of the processing units” specifically means executing a convolution operation of the generated space filters on a luminance value of a pixel when the processing unit is one pixel or luminance values of a plurality of pixels when the processing unit includes the plurality of pixels. As the luminance value, an appropriate luminance component can be selected based on a color space of the input image. For example, when the input image is in a YUV format, the luminance value may be a luminance component Y. Otherwise, the luminance value may be a brightness component L* of a CIE-L*a*b* space or a V component of an HSV space.

The display unit 106 consecutively displays the output image group generated by the processing execution unit 105 in a predetermined order. The display unit 106 is realized by the display unit 106, for example.

(Space Filter)

In this embodiment, a Gabor filter can be used as the space filter. The Gabor filter is a 2D filter generated using a function f (x, y, A, λ, ψ, γ, σ) described in Mathematical Formulae 1 to 3 below and is a function expressed by a trigonometric function as shown in Mathematical Formula 1.

$$\begin{matrix}f ( x , y , λ , φ , γ , σ ) = A cos ( \frac{2 {πx}^{′}}{λ} + φ ) {e}^{- \frac{{{x}^{′}}^{2} + {γ}^{2} {{y}^{′}}^{2}}{2 {σ}^{2}}} & ( Mathematical Formula 1 ) \\ {x}^{′} = x cos θ - y sin θ & ( Mathematical Formula 2 ) \\ {y}^{′} = x sin θ + y cos θ & ( Mathematical Formula 3 )\end{matrix}$$

FIGS. 3A and 3B each show a specific example of the Gabor filter. Planes S1 and S2 in the figures are each an xy plane, and a normal direction of the xy plane indicates a filter intensity. As shown in the figures, the Gabor filters each have a so-called Mexican-hat shape including an envelope. Specifically, the Gabor filter shown in FIG. 3A includes a peak Pll having a high intensity and a bottom B11 having a low intensity, and the Gabor filter shown in FIG. 3B similarly includes a peak P21 and bottoms B21 and B22.

In FIG. 3B, for example, the peak P21 having a high intensity is at a center portion, and the bottoms B21 and B22 are at both sides thereof. On the other hand, in FIG. 3A, the position of the peak P11 is deviated from the center, and only one bottom B11 exists. The shapes as described above are specified by the parameters x, y, λ, ψ, γ, σ and a coefficient A to be described below.

In Mathematical Formula 1, x and y indicate coordinate values on the input image. More specifically, positions of pixels in a calculation target pixel group are specified by values of (x, y). In addition, the range of x and y values may be specified as a filter size. The filter size herein refers to a 2D filter size specified by x and y and is a parameter that defines a range of the calculation target pixel group. The filter size (filter size) as the parameter may take a value satisfying P=2*(filter_size)+1 in the case of a size applicable to P×P pixels including a center pixel, for example. The filter size can be set to be, for example, about 1×1 to 9×9.

When the Gabor filter as those shown in FIGS. 3A and 3B is applied to a certain pixel (center pixel), a weight of the pixel in the calculation target pixel group corresponding to the coordinates (x, y) of the peak having a high intensity and the like becomes large, and a weight of the pixel in the calculation target pixel group corresponding to the coordinates (x, y) of the bottom having a low intensity and the like becomes small. In other words, when Gabor filters having different shapes are applied to a certain pixel, the weighting distribution of the calculation target pixel group differs, and thus the luminance values of the pixels also differ.

λ in Mathematical Formula 1 is a parameter that specifies a cycle from top to top or bottom to bottom in a waveform of the Gabor filter. When the value of λ becomes larger, the cycle becomes shorter. Therefore, a large number of peaks and bottoms appear so that the filter functions as a so-called high-pass filter. On the other hand, when λ becomes smaller, the cycle becomes longer. Therefore, the number of peaks and bottoms becomes small so that the filter functions as a so-called low-pass filter.

γ in Mathematical Formula 1 is a parameter that specifies an xy symmetry property of the Gabor filter shape, and with a value smaller than 1 as γ, a distorted movement like an elliptic movement is apt to be sensed.

σ in Mathematical Formula 1 is a parameter that specifies a gradient of the envelope of the Gabor filter. The value of σ is not limited in particular, but as the value of σ becomes larger, blurring is apt to become larger, and as the value of σ becomes smaller, edges are apt to be emphasized. The value of σ can be set to a value about ⅓ the filter size (p described above) in this embodiment.

θ in Mathematical Formulae 2 and 3 is a value that indicates a rotation angle of the Gabor filter on the xy plane and is a parameter that specifies a direction of the movement to be sensed. The filters shown in FIGS. 3A and 3B are filters including different values of θ. As shown in the figures, the shape shown in FIG. 3B rotates about the normal component of the xy plane when seen from the shape shown in FIG. 3A.

A in Mathematical Formula 1 is a coefficient of the Gabor filter function and may be specified based on image information. For example, as the numerical value of A becomes smaller, the image quality becomes closer to that of an input image. As a result, the filter may tend to be emphasized and blurring may tend to become large when the numerical value of A becomes large.

ψ in Mathematical Formula 1 is a phase parameter of the Gabor filter that specifies a size of a movement, the way a change in an image is seen, and the like. More specifically, ψ determines a height (intensity) and position of the peak and bottom in the Mexican-hat shape (see FIGS. 3A and 3B). Specifically, by varying the value of ψ, the positions of the peak and bottom can be varied.

In this embodiment, the filter generation unit 104 can set, for each of the processing units, values of at least a part of the parameters described above based on the control amount so as to generate the Gabor filter function. Specifically, for example, the size of the movement can be specified by the values ofψ and filter_size, and the direction of the movement can be specified by the value of θ. Further, the parameters other than ψ, filter_size, and θ can be specified based on image information or may be set in advance. For example, by setting the value of σ based on scene information, sharpness of edges can be adjusted according to the composition type.

The filter generation unit 104 can also set a plurality of different values for ψ. More specifically, when the plurality of values of ψ are seen as one numerical sequence in which the values are arranged in an ascending order, the filter generation unit 104 can set a difference between the values of two adjacent items to become larger as the size of the movement specified by the control amount becomes larger. For example, the plurality of values of ψ may be arranged in an arithmetic sequence. Moreover, since ψ as the phase parameter of the trigonometric function generally has a 2π periodicity, the plurality of values of ψ may be set to numerical values of 2π or less. Accordingly, the Gabor filters in which the positions of the peaks and bottoms are varied at predetermined intervals can be applied to each of the processing units, and when the output image group is reproduced, it gives an impression that the luminance values of pixels to which the filters are applied change consecutively. Therefore, as the entire image, it may give an impression as if the object is moving.

On the other hand, the present technology can also use a space filter that uses a gauss function in addition to the Gabor filter (see Non-patent Document 1). Such a space filter uses a function F(x, t) obtained by combining a secondary differentiation function G″(x) of a gauss function G(x) and an orthogonal function H(x) of G″(x), for example. Specifically, as shown in Mathematical Formula 4, the function is calculated by a weighted average of G″(x) and H(x) and includes a time t as the phase parameter.

F(x, t)=cos(t)G″(x)+sin(t)H(x) (Mathematical Formula 4)

FIG. 4A is a graph showing shape examples of G(x) (symbol G0), G′(x) (symbol G1), and G″(x) (symbol G2). FIG. 4B is a graph showing shape examples of G″(x) (symbol G2), H(x) (symbol H), and F(x, t) (symbol F) used as a space filter. Here, H(x) is derived from Hilbert transform of G″(x). The Hilbert transform involves deriving a Fourier coefficient of a real part and an imaginary part by discrete Fourier transform and carrying out inverse Fourier transform after transforming the coefficient. Furthermore, by using a trigonometric function on G″(x) and H(x) as weighting as shown in Mathematical Formula 4, a phase filter having cyclic characteristics with respect to the time t can be generated.

FIG. 5 is a graph showing a shape example of F(x, t) at a different time t. Also when a space filter that uses the function shown in Mathematical Formula 4 is applied as shown in the figure, a plurality of output images that differ depending on the time can be obtained by varying t as the phase parameter, and an output image group that can give an impression as if an object is moving when these images are consecutively reproduced can be generated.

It should be noted that although a 1D filter is illustrated for description in Mathematical Formula 4 and FIGS. 4 and 5, a 2D filter further including a parameter y is used for an actual input image.

In this embodiment, the Gabor filter can be used. Accordingly, operational costs can be largely reduced as compared to the case of using a space filter that uses the gauss function which requires Hilbert transform. Moreover, according to the Gabor filter, the parameter values to be set are apt to be determined intuitively from the shape of the filter to be generated as described above, and thus generation of space filters also becomes easy.

(Operation Example of Image Processing Apparatus)

FIG. 6 is a flowchart showing operations of the image processing apparatus 100.

First, the image acquisition unit 101 acquires an input image to be processed via the input/output interface 15 (ST61). The input image to be processed is one still image taken by an image pickup apparatus (not shown) or the like, for example, but it may alternatively be one frame of a moving image.

Subsequently, the image information analysis unit 102 analyzes image information from the acquired input image (ST62).

Specifically, for example, the depth information analysis unit 102a analyzes depth information. Here, the analyzed depth information is stored in the storage unit 18 as a depth image.

Further, the composition estimation unit 102f of the scene information estimation unit 102b estimates a spatial configuration in the input image and categorizes it into, for example, indoor, near view, and distant view. Similarly, the object estimation unit 102g of the scene information estimation unit 102b estimates a type of an object in the input image and categorizes it into, for example, person(s), natural landscape, or urbanscape.

Further, the vanishing point/vanishing line estimation unit 102c estimates at least one of a vanishing point and a vanishing line of the input image and stores information on the vanishing point/vanishing line in association with the XY coordinates allocated to the input image.

Further, the motion vector estimation unit 102d estimates, when the input image is one of a plurality of images that include the same object and may be reproduced temporally consecutively, a motion vector of the object in the input image, that is estimated from the plurality of images.

Furthermore, the gaze area estimation unit 102e estimates a gaze area presumed to be gazed out of the input image.

Subsequently, the control amount regulation unit 103 specifies a control amount of a movement to be sensed for each of the processing units based on the image information (ST63). Specifically, the control amount regulation unit 103 specifies, for each of the processing units, a depth amount specifying a size of the movement and xy coordinate values specifying a direction of the movement as the control amount. Hereinafter, an example of specifying a control amount based on image information will be described.

For example, the control amount regulation unit 103 can specify a control amount so as to enable a movement to be sensed more largely in a processing unit having a smaller depth than a processing unit having a larger depth based on the depth information analyzed by the depth information analysis unit 102a. As a result, it becomes possible to cause a sense of depth (stereoscopic effect). Alternatively, the control amount regulation unit 103 can cause a direction in which the movement is to be sensed to differ between an object having a smaller depth and an object having a larger depth, that have been analyzed by the depth information analysis unit 102a, for example.

When scene information is estimated by the scene information estimation unit 102b, for example, the control amount regulation unit 103 can specify the control amount for each of the processing units based on the scene information.

More specifically, when a scene of the input image is categorized as indoor or near view by the composition estimation unit 102f, for example, the control amount regulation unit 103 can specify the control amount such that the movement of the object becomes large. Accordingly, the object feels more closer, and thus the image feels natural and real. Alternatively, when a scene of the input image is categorized as indoor or near view, the control amount regulation unit 103 can set a difference in the movement sizes to become large between an object analyzed as being close by the depth information analysis unit 102a and an object analyzed as being far by the depth information analysis unit 102a. As a result, the stereoscopic effect can be emphasized more.

Further, the control amount regulation unit 103 can specify the control amount so as not to impart a movement to an object estimated to be a person by the object estimation unit 102g , for example. Accordingly, it becomes possible to make the object as a person look natural.

When a position of at least one of the vanishing point and vanishing line is estimated by the vanishing point/vanishing line estimation unit 102c, for example, the control amount regulation unit 103 can specify the control amount such that a movement that is directed toward or moves away from at least one of the vanishing point and the vanishing line is sensed. For example, when the position of the vanishing point is estimated, the control amount regulation unit 103 can specify the control amount such that a movement is felt in a direction about the vanishing point. As a result, it becomes possible to feel the sense of depth and the stereoscopic effect more.

When a motion vector is estimated by the motion vector estimation unit 102d, for example, the control amount regulation unit 103 can specify the movement size and movement direction as the control amount based on the motion vector. More specifically, the control amount regulation unit 103 can specify the control amount such that a movement can be felt based on the movement size and direction of the object expressed by the motion vector. Accordingly, it becomes possible to make people feel that the object is moving naturally.

When a gaze area is estimated by the gaze area estimation unit 102e, for example, the control amount regulation unit 103 can specify different control amounts for the gaze area and areas excluding the gaze area. More specifically, the control amount regulation unit 103 can specify the control amount such that the movement of the object in the gaze area feels larger than that in the areas excluding the gaze area. Alternatively, the control amount can be specified such that the movement of the object in the gaze area slightly differs from that of peripheral areas.

Subsequently, the filter generation unit 104 generates, for each of the processing units, a plurality of space filters capable of generating an output image group with which a movement is to be sensed from the input image based on the specified control amount (ST64). For example, the filter generation unit 104 specifies, out of the control amount of each of the processing units, the values of the phase ψ and filter_size corresponding to the movement size and the value of θ corresponding to the movement direction. The filter generation unit 104 calculates a Gabor filter function (see Mathematical Formula 1) into which the parameter values are substituted for each of the processing units.

In this case, the filter generation unit 104 can set a plurality of values of ψ as described above. When the plurality of values of 1 constitute a numerical sequence in which the values are arranged in an ascending order, a difference between two adjacent items can be set based on the control amount. Moreover, the difference in the values of ψ between the two adjacent items can be set to become larger as the movement becomes larger, or the range of the plurality of values of ψ may be set within the range of (0, 2π) in view of the 2π periodicity of ψ. Accordingly, the plurality of space filters having different values of ψ can be generated for each of the processing units.

Subsequently, the processing execution unit 105 applies the plurality of space filters to each of the processing units of the input image and generates an output image group (ST65). The processing execution unit 105 first applies one of the plurality of space filters to each of the processing units of the input image and generates one output image and repeats this processing for the plurality of space filters in each of the processing units to thus generate a plurality of output images.

Finally, the display unit 106 sequentially displays the generated output image group at predetermined timings.

As described above, according to this embodiment, an output image group that gives an impression as if an object is moving can be generated from one input image, and the movement can be specified based on image information. Accordingly, it becomes possible to generate an output image group that exhibits the sense of depth and stereoscopic effect more and is closer to the real thing.

Further, according to this embodiment, since the Gabor filter is used as the space filter, operational costs can be reduced comparatively. Moreover, since the parameter values can be set intuitively from the shape of filters to be generated, space filters can be generated with ease.

### MODIFIED EXAMPLE 1-1

Although the embodiment above describes that the filter generation unit 104 is capable of generating the plurality of space filters by calculating a function into which the parameter values corresponding to the control amount are substituted, the present technology is not limited thereto. For example, it is also possible for the storage unit 18 to store a lookup table including a plurality of array groups applicable as the plurality of space filters and the filter generation unit 104 to select an array group from the stored lookup table for each of the processing units based on the control amount. Here, one array group is an array group constituting a space filter that can be applied to one pixel (center pixel) and specifies a weighting value allocated to each pixel of the calculation target pixel group, for example. The number of arrays included in one array group may be specified by filter size.

When the filter generation unit 104 applies space filters that use a function, one array group may include a plurality of arrays into which values of a coordinate parameter (x, y) corresponding to each pixel of the calculation target pixel group are substituted. Moreover, when an array group is selected for each of the processing units, the filter generation unit 104 can select a plurality of array groups having different phase parameter values, the plurality of array groups corresponding to the function into which the parameter values are substituted based on the control amount.

Accordingly, operational effects similar to those of the embodiment above, in which the space filters are generated for each processing, can be obtained, and processing costs can be significantly reduced since time and effort in repetitively generating space filters can be omitted.

It should be noted that the storage unit 18 may store each of the array groups while directly associating the array group with the control amount. As a result, the filter generation unit 104 can smoothly select an array group from the array groups in the lookup table based on the control amount, and additionally reduce processing costs. Alternatively, the storage unit 18 may store each of the array groups in association with a function to be used for the space filter.

### MODIFIED EXAMPLE 1-2

In the embodiment above, the depth information, scene information, information on a vanishing point/vanishing line, information on a motion vector, and information on a gaze area are all used as the feature amount. However, at least one of these pieces of information may be used.

Alternatively, elements other than those described above may be used as the feature amount.

Further, the image information is not limited to the feature amount. For example, metadata of an input image may be used as the image information. Examples of the metadata include information on a focal distance of a lens and a shooting location.

### MODIFIED EXAMPLE 1-3

Although the Gabor filter is used as the space filter in the embodiment above, the present technology is not limited thereto. For example, a space filter that uses a gauss function, which has been taken as an example of the space filter (see Mathematical Formula 4 and FIGS. 4 and 5), or other functions expressed by a trigonometric function may be used. Further, a filter obtained by combining the Gabor filter and other functions may also be used as the space filter, for example. Furthermore, as long as it is a function capable of generating a plurality of space filters with which an output image group, that causes a movement to be sensed, can be generated from an input image, the present technology is not limited to even the function expressed by a trigonometric function.

### MODIFIED EXAMPLE 1-4

Although the control amount may be a value that specifies a movement size, xy coordinates that specify a movement direction, or a motion vector that indicates the movement size and direction in the embodiment above, the present technology is not limited thereto. For example, the control amount may be specified as a parameter value of a function used for the space filter. In addition, the control amount is not limited to an amount that specifies at least one of a size and direction of a movement to be sensed and may be an amount that specifies a velocity or acceleration of the movement, and the like. Alternatively, when the movement is a rotary movement, the control amount may be a rotation amount or rotation velocity of the movement.

### MODIFIED EXAMPLE 1-5

Although the embodiment above describes that values of parameters other than the parameters corresponding to the control amount may be set in advance for the space filters, the present technology is not limited thereto. For example, the filter generation unit 104 may set values of parameters other than the parameters corresponding to the control amount based on image information. For example, when an object is estimated to be a natural landscape based on scene information, the value of σ can be set relatively largely. As a result, it becomes possible to provide an output image group closer to the actual natural landscape without emphasizing edges of the object too much. Further, when the object is estimated to be an urbanscape, the value of σ can be set to be relatively small, for example. Accordingly, it becomes possible to emphasize edges of the object and create a more-urban atmosphere with many artificial materials.

Therefore, according to this modified example, image information can be used effectively to provide an output image closer to the real thing.

### MODIFIED EXAMPLE 1-6

Alternatively, values of parameters other than the parameters corresponding to the control amount may be set by a user. In this case, for example, parameter values of several types of patterns may be set in advance so that those patterns can be selected based on a user input. For example, the patterns may be configured to be selectable according to user preferences as in a mode that emphasizes edges, a mode that does not emphasize edges, a high-definition mode, and the like. When the Gabor filter is applied, for example, the value of σ can be set to be relatively small in the mode that emphasizes edges, and the value of σ can be set relatively largely in the mode that does not emphasize edges. In the high-definition mode, it is possible to set the value of A to be relatively small and the value of γ to be relatively large.

Accordingly, an output image group can be controlled based on preferences of a user him/herself and thus additionally enhance user satisfaction.

### Second Embodiment

(Hardware Configuration of Image Processing System)

FIG. 7 is a block diagram showing a hardware configuration of an image processing system 2 according to a second embodiment of the present technology. In the figure, the image processing system 2 is a cloud system and includes an image processing apparatus 200 and a display apparatus 260. The image processing apparatus 200 and the display apparatus 260 are connected to each other via a network N. The display apparatus 260 is configured as a user terminal such as a PC, a tablet PC, a smartphone, and a tablet terminal, and the image processing apparatus 200 is configured as a server apparatus (information processing apparatus) on the network N, for example.

The image processing system 2 is capable of performing operations as follows. Specifically, the image processing apparatus 200 extracts image information from an input image transmitted from the display apparatus 260, generates space filters to generate an output image group, and transmits the output image group to the display apparatus 260. Then, the display apparatus 260 displays the received output image group.

The display apparatus 260 includes a controller 261, a ROM 262, a RAM 263, an input/output interface 265, and a bus 264 mutually connecting them. Further, a display 266, an operation reception unit 267, a storage unit 268, a communication unit 269, and the like are connected to the input/output interface 265. The controller 261, the ROM 262, the RAM 263, the bus 264, the input/output interface 265, the display 266, the operation reception unit 267, the storage unit 268, and the communication unit 269 respectively have configurations similar to those of the controller 11, the ROM 12, the RAM 13, the bus 14, the input/output interface 15, the display 16, the operation reception unit 17, the storage unit 18, and the communication unit 19, so descriptions thereof will be omitted. It should be noted that an image pickup unit (not shown) and the like may also be connected to the input/output interface 265 of the display apparatus 260.

The image processing apparatus 200 includes a controller 21, a ROM 22, a RAM 23, an input/output interface 25, and a bus 24 mutually connecting them. Further, a display 26, an operation reception unit 27, a storage unit 28, a communication unit 29, and the like are connected to the input/output interface 25. The controller 21, the ROM 22, the RAM 23, the bus 24, the input/output interface 25, the display 26, the operation reception unit 27, the storage unit 28, and the communication unit 29 respectively have configurations similar to those of the controller 11, the ROM 12, the RAM 13, the bus 14, the input/output interface 15, the display 16, the operation reception unit 17, the storage unit 18, and the communication unit 19, so descriptions thereof will be omitted.

(Functional Configuration of Image Processing System)

FIG. 8 is a block diagram showing a functional configuration of the image processing system 2. As shown in the figure, the image processing system 2 includes an image acquisition unit 201, an image information analysis unit 202, a control amount regulation unit 203, a filter generation unit 204, a processing execution unit 205, and a display unit 206. Of those, the image processing apparatus 200 includes the image acquisition unit 201, the image information analysis unit 202, the control amount regulation unit 203, the filter generation unit 204, and the processing execution unit 205. The display apparatus 260 includes the display unit 206.

The elements described above respectively have configurations similar to those of the image acquisition unit 101, the image information analysis unit 102, the control amount regulation unit 103, the filter generation unit 104, the processing execution unit 105, and the display unit 106 of the image processing apparatus 100. In other words, the image acquisition unit 201 acquires an input image to be processed. The image information analysis unit 202 analyzes image information from the acquired input image and includes a depth information analysis unit 202a, a scene information estimation unit 202b, a vanishing point/vanishing line estimation unit 202c, a motion vector estimation unit 202d, and a gaze area estimation unit 202e. The filter generation unit 204 generates, for each of the processing units, a plurality of space filters with which an output image group, that causes a movement to be sensed, can be generated from the input image based on a specified control amount. The processing execution unit 205 applies the plurality of space filters generated by the filter generation unit 204 to each of the processing units of the input image to generate an output image group. The display unit 206 consecutively displays the output image group generated by the processing execution unit 205 in a predetermined order. Specific descriptions of these elements will be omitted.

It should be noted that the image acquisition unit 201 may acquire an image that is transmitted from the display apparatus 260 via the communication unit 269 and stored in the storage unit 28 as the input image, for example. Alternatively, an image stored in a database on a network or the like may be acquired as the input image based on a user operation with respect to the display apparatus 260.

The output image group generated by the processing execution unit 205 is transmitted to the display apparatus 260 via the communication unit 29 and the communication unit 269 to be displayed on the display unit 206. The display unit 206 is realized by the display 266 of the display apparatus 260, for example.

Even the image processing apparatus 200 having the configuration as described above is capable of generating an output image group, that exhibits the sense of depth and stereoscopic effect more and is closer to the real thing, based on image information similar to the image processing apparatus 100.

Further, according to this embodiment, it becomes possible to generate an output image group with which a movement can be sensed using a cloud system. Accordingly, the output image group can be displayed to the user while reducing a load on the user terminal such as the display apparatus 260 due to image processing.

### Third Embodiment

(Schematic Configuration of Image Processing System)

FIG. 9 is a block diagram showing a schematic configuration of an image processing system 3 according to a third embodiment of the present technology. In the figure, the image processing system 3 is a cloud system and includes an image processing apparatus 300 and a display apparatus 360. The image processing apparatus 300 and the display apparatus 360 are connected to each other via the network N. The display apparatus 360 is configured as a user terminal, and the image processing apparatus 300 is configured as a server apparatus (information processing apparatus) on the network N, for example. The hardware configurations of the image processing apparatus 300 and the display apparatus 360 are similar to those of the image processing apparatus 200 and the display apparatus 260, so descriptions thereof will be omitted.

The image processing system 3 is capable of performing operations as follows. Specifically, the image processing apparatus 300 extracts image information from an input image transmitted from the display apparatus 360, generates space filters, and transmits them to the display apparatus 360. The display apparatus 360 generates an output image group by applying the space filters received from the image processing apparatus 300 to the input image and displays it.

(Functional Configuration of Image Processing System)

FIG. 10 is a block diagram showing a functional configuration of the image processing system 3. As shown in the figure, the image processing system 3 includes an image acquisition unit 301, an image information analysis unit 302, a control amount regulation unit 303, a filter generation unit 304, a processing execution unit 305, and a display unit 306. Of those, the image processing apparatus 300 includes the image acquisition unit 301, the image information analysis unit 302, the control amount regulation unit 303, and the filter generation unit 304. The display apparatus 360 includes the processing execution unit 305 and the display unit 306.

The elements described above respectively have configurations similar to those of the image acquisition unit 101, the image information analysis unit 102, the control amount regulation unit 103, the filter generation unit 104, the processing execution unit 105, and the display unit 106 of the image processing apparatus 100. In other words, the image acquisition unit 301 acquires an input image to be processed. The image information analysis unit 302 analyzes image information from the acquired input image and includes a depth information analysis unit 302a, a scene information estimation unit 302b, a vanishing point/vanishing line estimation unit 302c, a motion vector estimation unit 302d, and a gaze area estimation unit 302e. The filter generation unit 304 generates, for each of the processing units, a plurality of space filters with which an output image group, that causes a movement to be sensed, can be generated from the input image based on a specified control amount. The processing execution unit 305 applies the plurality of space filters generated by the filter generation unit 304 to each of the processing units of the input image to generate an output image group. The display unit 306 consecutively displays the output image group generated by the processing execution unit 305 in a predetermined order. Specific descriptions of these elements will be omitted.

The plurality of space filters generated by the filter generation unit 304 of the image processing apparatus 300 are transmitted to the display apparatus 360 via a communication unit (not shown). At this time, the input image may be transmitted with the space filters, or only the space filters may be transmitted when the input image is stored in a storage unit (not shown) of the display apparatus 360. Position information of pixels in an input image to be applied and information including a reproduction order in the plurality of space filters to be applied to the pixels are associated with the space filters to be transmitted.

The processing execution unit 305 is realized by a controller (not shown) of the display apparatus 360, for example. Based on the information associated with each of the space filters, the processing execution unit 305 applies the transmitted space filters to each of the processing units of the input image and generates an output image group.

The display unit 306 is realized by a display (not shown) of the display apparatus 360, for example. By the display unit 306, the output image group is successively displayed from the display apparatus 360 at predetermined intervals.

Even the image processing apparatus 300 having the configuration as described above is capable of generating an output image group, that exhibits a sense of depth and a stereoscopic effect and is closer to the real thing, similar to the image processing apparatus 100. Further, according to this embodiment, it becomes possible to generate an output image group with which a movement can be sensed using a cloud system as in the second embodiment.

### Fourth Embodiment

(Schematic configuration of image processing system) FIG. 11 is a block diagram showing a schematic configuration of an image processing system 4 according to a fourth embodiment of the present technology. In the figure, the image processing system 4 is a cloud system and includes an image processing apparatus 400 and a display apparatus 460. The image processing apparatus 400 and the display apparatus 460 of the image processing system 4 are connected to each other via the network N. The display apparatus 460 is configured as a user terminal, and the image processing apparatus 400 is configured as a server apparatus (information processing apparatus) on the network N, for example. It should be noted that the hardware configurations of the image processing apparatus 400 and the display apparatus 460 are similar to those of the image processing apparatus 200 and the display apparatus 260, so descriptions thereof will be omitted.

The image processing system 4 is capable of performing operations as follows. Specifically, the display apparatus 460 analyzes image information from an input image and transmits the image information to the image processing apparatus 400 together with the input image. Based on the image information, the image processing apparatus 400 generates space filters to generate an output image group, and transmits it to the display apparatus 460. Then, the display apparatus 460 applies the space filters to the input image and generates and reproduces the output image group.

(Functional Configuration of Image Processing System)

FIG. 12 is a block diagram showing a functional configuration of the image processing system 4. As shown in the figure, the image processing system 4 includes an image acquisition unit 401, an image information analysis unit 402, a control amount regulation unit 403, a filter generation unit 404, a processing execution unit 405, and a display unit 406. Of those, the image processing apparatus 400 includes the control amount regulation unit 403, the filter generation unit 404, and the processing execution unit 405. The display apparatus 460 includes the image acquisition unit 401, the image information analysis unit 402, and the display unit 406.

The elements described above respectively have configurations similar to those of the image acquisition unit 101, the image information analysis unit 102, the control amount regulation unit 103, the filter generation unit 104, and the processing execution unit 105 of the image processing apparatus 100. In other words, the image acquisition unit 401 acquires an input image to be processed. The image information analysis unit 402 analyzes image information from the acquired input image and includes a depth information analysis unit 402a, a scene information estimation unit 402b, a vanishing point/vanishing line estimation unit 402c, a motion vector estimation unit 402d, and a gaze area estimation unit 402e. The filter generation unit 404 generates, for each of the processing units, a plurality of space filters with which an output image group, that causes a movement to be sensed, can be generated from the input image based on a specified control amount. The processing execution unit 405 applies the plurality of space filters generated by the filter generation unit 404 to each of the processing units of the input image to generate an output image group. The display unit 406 consecutively displays the output image group generated by the processing execution unit 405 in a predetermined order. Specific descriptions of these elements will be omitted.

The image acquisition unit 401 and the image information analysis unit 402 are realized by a controller (not shown) of the display apparatus 460, for example. The image information analyzed from the input image by the display apparatus 460 is transmitted to the image processing apparatus 400 via communication units (not shown) of the display apparatus 460 and image processing apparatus 400. It should be noted that at this time, the input image may either be transmitted or not transmitted with the image information.

The display unit 406 is realized by a display (not shown) of the display apparatus 460, for example. Similar to the display unit 206, the display unit 406 consecutively displays the output image group in a predetermined order based on a user operation and the like. Accordingly, the output image group is successively displayed from the display apparatus 460.

Even the image processing apparatus 400 having the configuration as described above is capable of generating an output image group, that exhibits a sense of depth and a stereoscopic effect and is closer to the real thing, similar to the image processing apparatus 100. Further, according to this embodiment, it becomes possible to generate an output image group with which a movement can be sensed using a cloud system as in the second embodiment.

### MODIFIED EXAMPLE 4-1

Although the fourth embodiment above describes that the image processing apparatus 400 includes the control amount regulation unit 403, the filter generation unit 404, and the processing execution unit 405, the present technology is not limited thereto. For example, instead of the image processing apparatus 400 including the processing execution unit 405, the display apparatus 460 may include the processing execution unit 405. In this case, as in the third embodiment, the plurality of space filters generated by the filter generation unit 404 of the image processing apparatus 400 are transmitted to the display apparatus 460 via communication units (not shown), and an output image group is generated on the display apparatus 460 side. Also with such a configuration, operational effects similar to those of the embodiment above can be obtained.

### MODIFIED EXAMPLE 4-2

Although the fourth embodiment above describes that the display apparatus 460 includes the image information analysis unit 402, the present technology is not limited thereto. For example, as shown in FIG. 13, the image processing apparatus 400 may include the image information analysis unit 402, the control amount regulation unit 403, the filter generation unit 404, and the processing execution unit 405. In other words, the input image acquired by the image acquisition unit 401 of the display apparatus 460 is transmitted to the image processing apparatus 400 via communication units (not shown) of the display apparatus 460 and image processing apparatus 400. The image processing apparatus 400 carries out processing using the input image and transmits an output image group to the display apparatus 460 in response to a request from the display apparatus 460 and the like. Also with such a configuration, operational effects similar to those of the embodiment above can be obtained.

Furthermore, the present invention is not limited to the embodiments described above and can be variously modified without departing from the gist of the present disclosure. In addition, the first to fourth embodiments and examples described above may be combined anyhow as long as no contradiction is caused.

It should be noted that the present technique may also take the following configurations.
(1) An image processing apparatus, including:

a control amount regulation unit that specifies, based on image information of an input image including a plurality of processing units, a control amount of a movement to be sensed for each of the processing units; and

a filter generation unit that generates, for each of the processing units, a plurality of space filters with which an output image group, that causes the movement to be sensed, can be generated from the input image based on the specified control amount.
(2) The image processing apparatus according to (1), in which

the control amount is an amount that specifies at least one of a size and a direction of the movement to be sensed.
(3) The image processing apparatus according to (1) or (2), in which

the image information includes a feature amount extracted from the input image.
(4) The image processing apparatus according to (3), in which

the feature amount includes depth information of the input image, and

the control amount regulation unit specifies, based on the depth information, the control amount such that the movement is sensed more largely in a processing unit having a larger depth than a processing unit having a smaller depth.
(5) The image processing apparatus according to (3) or (4), in which

the feature amount includes scene information on a scene estimated from the input image, and

the control amount regulation unit specifies the control amount for each of the processing units based on the scene information.
(6) The image processing apparatus according to (5), in which

the scene information includes information on a space configuration in the input image.
(7) The image processing apparatus according to (5) or (6), in which

the scene information includes information on a type of an object of the input image.
(8) The image processing apparatus according to any one of (3) to (7), in which

the feature amount includes information on a position of at least one of a vanishing point and a vanishing line of the input image, and

the control amount regulation unit specifies the control amount such that a movement toward at least one of the vanishing point and the vanishing line or a movement that moves away from at least one of the vanishing point and the vanishing line is sensed.
(9) The image processing apparatus according to any one of (3) to (8), in which

the input image is one of a plurality of images that include the same object and can be reproduced temporally consecutively,

the feature amount includes information on a motion vector of the object in the input image, that is estimated from the plurality of images, and

the control amount regulation unit specifies, as the control amount, a size and direction of the movement based on the motion vector.
(10) The image processing apparatus according to any one of (3) to (9), in which

the feature amount includes information on a gaze area presumed to be gazed out of the input image, and

the control amount regulation unit specifies different control amounts for the gaze area and areas excluding the gaze area.
(11) The image processing apparatus according to any one of (1) to (10), further including:

an image acquisition unit that acquires the input image; and

an image information analysis unit that analyzes the image information from the input image.
(12) The image processing apparatus according to any one of (1) to (11), in which

each of the plurality of space filters includes a function expressed by a trigonometric function, the functions of the plurality of space filters including different phase parameter values.
(13) The image processing apparatus according to (12), in which

the plurality of space filters each include a Gabor filter, the Gabor filters of the plurality of space filters including different phase parameter values.
(14) The image processing apparatus according to any one of (1) to (13), further including

a storage unit that stores a lookup table including a plurality of array groups that can be applied as the plurality of space filters,

in which the filter generation unit selects an array group from the lookup table for each of the processing units based on the control amount.
(15) The image processing apparatus according to any one of (1) to (14), further including

a processing execution unit that applies the plurality of space filters to each of the processing units of the input image to generate an output image group.
(16) An image processing method, including:

specifying, based on image information of an input image including a plurality of processing units, a control amount of a movement to be sensed for each of the processing units; and

generating, for each of the processing units, a plurality of space filters with which an output image group, that causes the movement to be sensed, can be generated from the input image based on the specified control amount.
(17) A program that causes an image processing apparatus to execute the steps of:

specifying, based on image information of an input image including a plurality of processing units, a control amount of a movement to be sensed for each of the processing units; and

generating, for each of the processing units, a plurality of space filters with which an output image group, that causes the movement to be sensed, can be generated from the input image based on the specified control amount.

### DESCRIPTION OF REFERENCE NUMERALS

101, 201, 301, 401 image acquisition unit
102, 202, 302, 402 image information analysis unit
103, 203, 303, 403 control amount regulation unit
104, 204, 304, 404 filter generation unit
105, 205, 305, 405 processing execution unit
100, 200, 300, 400 image processing apparatus

1. An image processing apparatus, comprising:
a control amount regulation unit that specifies, based on image information of an input image including a plurality of processing units, a control amount of a movement to be sensed for each of the processing units; and
a filter generation unit that generates, for each of the processing units, a plurality of space filters with which an output image group, that causes the movement to be sensed, can be generated from the input image based on the specified control amount.

2. The image processing apparatus according to claim 1, wherein
the control amount is an amount that specifies at least one of a size and a direction of the movement to be sensed.

3. The image processing apparatus according to claim 1, wherein
the image information includes a feature amount extracted from the input image.

4. The image processing apparatus according to claim 3, wherein
the feature amount includes depth information of the input image, and
the control amount regulation unit specifies, based on the depth information, the control amount such that the movement is sensed more largely in a processing unit having a larger depth than a processing unit having a smaller depth.

5. The image processing apparatus according to claim 3, wherein
the feature amount includes scene information on a scene estimated from the input image, and
the control amount regulation unit specifies the control amount for each of the processing units based on the scene information.

6. The image processing apparatus according to claim 5, wherein
the scene information includes information on a space configuration in the input image.

7. The image processing apparatus according to claim 5, wherein
the scene information includes information on a type of an object of the input image.

8. The image processing apparatus according to claim 3, wherein
the feature amount includes information on a position of at least one of a vanishing point and a vanishing line of the input image, and
the control amount regulation unit specifies the control amount such that a movement toward at least one of the vanishing point and the vanishing line or a movement that moves away from at least one of the vanishing point and the vanishing line is sensed.

9. The image processing apparatus according to claim 3, wherein
the input image is one of a plurality of images that include the same object and can be reproduced temporally consecutively,
the feature amount includes information on a motion vector of the object in the input image, that is estimated from the plurality of images, and
the control amount regulation unit specifies, as the control amount, a size and direction of the movement based on the motion vector.

10. The image processing apparatus according to claim 3, wherein
the feature amount includes information on a gaze area presumed to be gazed out of the input image, and
the control amount regulation unit specifies different control amounts for the gaze area and areas excluding the gaze area.

11. The image processing apparatus according to claim 1, further comprising:
an image acquisition unit that acquires the input image; and
an image information analysis unit that analyzes the image information from the input image.

12. The image processing apparatus according to claim 1, wherein
each of the plurality of space filters includes a function expressed by a trigonometric function, the functions of the plurality of space filters including different phase parameter values.

13. The image processing apparatus according to claim 12, wherein
the plurality of space filters each include a Gabor filter, the Gabor filters of the plurality of space filters including different phase parameter values.

14. The image processing apparatus according to claim 1, further comprising
a storage unit that stores a lookup table including a plurality of array groups that can be applied as the plurality of space filters,
wherein the filter generation unit selects an array group from the lookup table for each of the processing units based on the control amount.

15. The image processing apparatus according to claim 1, further comprising
a processing execution unit that applies the plurality of space filters to each of the processing units of the input image to generate an output image group.

16. An image processing method, comprising:
specifying, based on image information of an input image including a plurality of processing units, a control amount of a movement to be sensed for each of the processing units; and
generating, for each of the processing units, a plurality of space filters with which an output image group, that causes the movement to be sensed, can be generated from the input image based on the specified control amount.

17. A program that causes an image processing apparatus to execute the steps of:
specifying, based on image information of an input image including a plurality of processing units, a control amount of a movement to be sensed for each of the processing units; and
generating, for each of the processing units, a plurality of space filters with which an output image group, that causes the movement to be sensed, can be generated from the input image based on the specified control amount.
